(19) United States
(12) Patent Application Publication
(10) Pub. No.: US 2020/0290554 A1
(43) Pub. Date: Sep. 17, 2020

(54) GAS GENERATOR

(71) Applicant: DAICEL CORPORATION, Osaka-shi, Osaka (JP)

(72) Inventor: Toshihiro IZUMA, Tokyo (JP)

(73) Assignee: DAICEL CORPORATION, Osaka-shi, Osaka (JP)

(21) Appl. No.: 16/645,234

(22) PCT Filed: Sep. 3, 2018
(86) PCT No.: PCT/JP2018/032522

§ 371 Date: Mar. 6, 2020

(30) Foreign Application Priority Data
Oct. 6, 2017 (JP) 2017-196288

(51) Int. Cl. B60R 21/264; B01D 46/24

(52) U.S. Cl. CPC B60R 21/264; B01D 2279/10; B01D 2265/00; B01D 46/24

(57) ABSTRACT

The present invention relates to a gas generator including a cylindrical filter in a housing including a gas discharge port, the housing including a plurality of independent protrusions or an annular protrusion protruding inwardly from an inner wall surface of the housing, the independent protrusions including an annular protruding wall surface, the annular protrusion including an annular tip surface, the cylindrical filter including a first annular end surface and a second annular end surface, a support member which includes an annular surface portion for supporting the cylindrical filter being arranged, the annular surface portion being an annular planar portion, or including an annular planar portion and a deformed portion for which all or a part of at least one of the inner peripheral portion and the outer peripheral portion of the annular planar portion is deformed, the support member being configured such that a part of the support member including an outer peripheral portion of the annular planar portion is arranged abutting against the annular protruding wall surface of the independent protrusions or the first annular protruding wall surface of the annular protrusion, and the second annular end surface of the cylindrical filter abutting against the annular planar portion of the support member, and the first annular end surface abutting against an inner wall surface of the housing.

### TECHNICAL FIELD

The present invention relates to a gas generator that can be used in an airbag device mounted in an automobile.

### BACKGROUND ART

A cylindrical filter is used in a gas generator using a gas generating agent as a gas generation source for the purpose of filtering and cooling combustion gas. When the cylindrical filter is arranged, for example, in a disk-shaped housing, one end surface is often arranged abutting against the top plate and the other end surface is arranged abutting against the bottom plate.

Since the cylindrical filter is heavy and expensive, it is conceivable to use a cylindrical filter that is miniaturized without reducing the filtration and cooling capacity. However, when a small cylindrical filter is used, it is not possible to support the small cylindrical filter by using both the top plate and the bottom plate, so it is necessary to support the filter by another method.

In FIG. 37 of U.S. Pat. No. 2016/0,052,485 A1, an invention is disclosed in which a filter 46 is mounted in a diffuser 10 using a protrusion (a supporting portion 124) formed by embossing protruding inside the housing.

### SUMMARY OF INVENTION

A first aspect of the present invention (hereinafter, referred to as a “first aspect”) provides a gas generator including, in a housing made of metal including a gas discharge port, a combustion chamber containing a gas generating agent, and a cylindrical filter arranged between the gas discharge port and the combustion chamber,

the housing including a plurality of independent protrusions or an annular protrusion protruding inwardly from an inner wall surface of the housing,

the plurality of independent protrusions including an annular protruding wall surface and a tip surface surrounded by the annular protruding wall surface,

the annular protrusion including an annular tip surface, a first annular protruding wall surface and a second annular protruding wall surface, the first annular protruding wall surface and the second annular protruding wall surface each extending, from both sides of the annular tip surface in the width direction, to the inner wall surface of the housing,

the cylindrical filter including a first annular end surface, a second annular end surface opposite the first annular end surface in an axial direction, an inner peripheral wall surface, and an outer peripheral wall surface,

furthermore, a metal support member which includes an annular surface portion for supporting the cylindrical filter being arranged inside the housing, the annular surface portion including only an annular planar portion, or an annular planar portion and a deformed portion, for which all or a part of at least one of an inner peripheral portion and an outer peripheral portion of the annular planar portion is deformed,

the support member being configured such that a part of the support member including the outer peripheral portion of the annular planar portion is arranged abutting against the annular protruding wall surface of the plurality of independent protrusions or the first annular protruding wall surface of the annular protrusion, and

the second annular end surface of the cylindrical filter abutting against the annular planar portion of the support member, and the first annular end surface of the cylindrical filter being arranged in a state of abutting against the inner wall surface of the housing, which faces the annular planar portion in an axial direction.

Another aspect of the first aspect of the present invention provides a gas generator, including

a housing made of metal and forming a combustion chamber therein,

a plurality of independent protrusions or an annular protrusion protruding inwardly from an inner wall surface of the housing, and in the gas generator,

a cylindrical filter which includes a first annular end surface and a second annular end surface opposite the first annular end surface in an axial direction being arranged in the housing, and

furthermore, a metal support member including an annular planar portion being arranged inside the housing, the annular surface portion including only an annular planar portion, or an annular planar portion and a deformed portion, for which all or a part of at least one of an inner peripheral portion and an outer peripheral portion of the annular planar portion is deformed, the support member being configured such that a part of the support member including the outer peripheral portion of the annular planar portion is arranged abutting against the plurality of independent protrusions or the annular protrusion, that the annular planar portion of the support member supports the second annular end surface of the cylindrical filter, and that the first annular end surface of the cylindrical filter is arranged in a state of being supported by an inner wall surface of the housing facing the annular planar portion in an axial direction.

A second aspect of the present invention (hereinafter, referred to as a “second aspect”) provides a gas generator, including, in a housing made of metal, a combustion chamber containing therein a gas generating agent, a cup member accommodating therein an igniter, and a cylindrical filter arranged between the gas discharge port and the combustion chamber,

the housing including a diffuser shell provided with a top plate portion, a first peripheral wall portion formed with a gas discharge port, and an opening, and a closure shell provided with a bottom plate portion, a second peripheral wall portion, and an opening, the housing being formed by fitting the closure shell into the inner side of the opening of the diffuser shell, and welding the closure shell and the diffuser shell at a contact portion therebetween,

the igniter being fixed to the bottom plate, the cup member covering the bottom plate and accommodating therein the igniter, and a bottom surface portion of the cup member being positioned toward the top plate,

the cylindrical filter including a first annular end surface, a second annular end surface opposite the first annular end surface in an axial direction, an inner peripheral wall surface, and an outer peripheral wall surface,

a cylindrical member made of metal for supporting the cylindrical filter, and a support member made of metal being arranged in the housing,

the cylindrical member including a cylindrical main body portion and a plurality of independent protrusions or an annular protrusion protruding inwardly from an inner wall surface of the cylindrical main body portion,

the plurality of independent protrusions including an annular protruding wall surface and a tip surface surrounded by the annular protruding wall surface,

the annular protrusion including an annular tip surface, a first annular protruding wall surface and a second annular protruding wall surface, the first annular protruding wall surface and the second annular protruding wall surface each extending, from both sides of the annular tip surface in the width direction, to an inner wall surface of the housing,

furthermore, the cylindrical main body portion being abutting against the second peripheral wall portion of the housing, and the plurality of independent protrusions or the annular protrusion being spaced from the first peripheral wall portion in a radial direction,

the support member including an annular planar portion provided with a plurality of through-holes in a thickness direction thereof, and an annular bent portion bent in one direction from an outer peripheral portion of the annular planar portion,

the support member being configured such that an inner peripheral portion of the annular planar portion is abutting against a peripheral wall portion of the cup member, and a tip portion of the annular bent portion is abutting against the annular protruding wall surface of the plurality of independent protrusions or the first annular protruding wall surface of the annular protrusion, and

the cylindrical filter being arranged in a state in which the outer peripheral wall surface thereof is abutting against the cylindrical main body portion of the cylindrical member, the inner peripheral wall surface thereof is abutting against the peripheral wall portion of the cup member, the first annular end surface thereof is abutting against the top plate, and the second annular end surface thereof is abutting against the annular planar portion of the support member.

### BRIEF DESCRIPTION OF DRAWINGS

The present invention will be more fully understood from the detailed description given hereinbelow and the accompanying drawings, which are given for explanation only and do not limit the present invention.

FIG. 1 is a cross-sectional view in an X-axis direction of a gas generator according to an embodiment of the present invention.

FIG. 2A is a cross-sectional view of a portion of FIG. 1 including a protrusion. FIG. 2B is a cross-sectional view of a portion of FIG. 1 including the protrusion and a support member, and FIG. 2C is an explanatory diagram of an angle R.

FIG. 3 is a cross-sectional view in the X-axis direction of a portion including a protrusion and a support member of a gas generator according to another embodiment.

FIG. 4 is a cross-sectional view in the X-axis direction of a portion including a protrusion and a support member of a gas generator according to yet another embodiment.

FIG. 5 is a cross-sectional view in the X-axis direction of a portion including a protrusion and a support member of a gas generator according to yet another embodiment.

FIG. 6 is a cross-sectional view in the X-axis direction of a gas generator according to yet another embodiment.

FIG. 7A is a plane view of a support member of a gas generator according to yet another embodiment. FIG.7B is a cross-sectional view in the X-axis direction of a portion including a protrusion and a support member of a gas generator according to another embodiment using the support member of FIG. 7A. FIG. 7C is a partial front view from the inside of FIG.7A.

FIG. 8A is a perspective view of a support member of a gas generator according to yet another embodiment. FIG. 8B is a cross-sectional view in the X-axis direction of a portion including a protrusion and a support member of a gas generator according to another embodiment using the support member of FIG. 8A.

FIG. 9 is a cross-sectional view in the X-axis direction of a gas generator according to yet another embodiment.

### DESCRIPTION OF EMBODIMENTS

In FIG. 37 of U.S. Pat. No. 2016/0,052,485 A1, since the protruding length of the supporting portion 124 is short, it is conceived that the following problems occur in terms of preventing the filter 46 from getting deformed and passing over the supporting portion 124.

Firstly, it is necessary to use a filter that is hard and less likely to be deformed (that is, a filter with inferior flexibility), but it is conceived that if such a filter 46 is used, the adhesion with the housing top plate 14 may deteriorate due to a decrease in the flexibility of the filter itself, and a short path may be generated through which the combustion gas is discharged without passing through the filter 46.

Secondly, it is necessary to press-fit the filter 46 by adjusting the outside diameter of the filter 46 and the inner diameter of the diffuser (housing) 10, but it is conceived that the press-fitting operation itself is difficult, and failures due to deformation of the filter 46 may occur.

Thirdly, it is necessary to form a taper portion on the end surface of the opening of the filter 46 (the double line of the opening of the filter 46 in FIG. 37 indicates the taper portion), and bring it to be abutting against the supporting portion 124, and thus, the forming accuracy of the filter 46 is important.

Furthermore, as can also be seen in FIG. 37, the outer peripheral surface near the opening of the filter 46 at the closing member 12 side is in contact with the inner wall surface of the closing member 12 (the inner peripheral surface of the edge 22), and therefore, the periphery of this contact portion will substantially not be utilized for filtering the combustion gas.

The present invention provides a gas generator including a support member for fixing a filter.

The housing of the gas generator according to the present invention is not only disk shaped, but a cylinder-shaped housing can also be used. However, a disk-shaped housing is preferable.

The cylindrical filter is of the same type as that used in a known gas generator, and the cross-sectional shape in the width direction is the same as the cross-sectional shape of the housing. Furthermore, the height of the cylindrical filter can be adjusted according to the shape and size of the housing, the position of the gas discharge port of the housing, the amount of the gas generating agent, and the like.

The housing is made of a metal such as iron, stainless steel, or the like, and includes a plurality of independent protrusions or an annular protrusion protruding inwardly from the inner wall surface of the housing. The plurality of independent protrusions include an annular protruding wall surface and a tip surface surrounded by the annular projecting wall surface, and are in the form of an “independent peak”.

When a plurality of independent protrusions are used, the plurality of independent protrusions are formed at intervals (preferably at equal intervals) in the circumferential direction. Each of the plurality of independent protrusions is formed at the same height position in the height direction of the housing.

The cross-sectional shape of the plurality of independent protrusions in the axial direction of the housing is substantially trapezoidal or substantially rectangular. The boundary between the annular protruding wall surface and the tip surface may be angled or may be roundish, but preferably roundish.

When the annular protrusion is adopted, the annular protrusion includes an annular tip surface, and a first annular protruding wall surface and a second annular protruding wall surface each of which extending from both sides of the annular tip surface in the width direction to the housing inner wall surface, and thus, is in the form of an “annular wall”.

The entire annular protrusion is formed at the same height position in the height direction of the housing. The cross-sectional shape of the annular protrusion in the axial direction of the housing is substantially trapezoidal or substantially rectangular. The boundary between the first annular protruding wall surface and the annular tip surface may be angled or may be roundish, but preferably roundish. The boundary between the second annular protruding wall surface and the annular tip surface may be angled or may be roundish.

The support member including an annular surface portion for supporting the cylindrical filter is one in which the annular surface portion includes only an annular planar portion, or includes an annular planar portion and a deformed portion, in the deformed portion, all or a part of at least one of the inner peripheral portion and the outer peripheral portion of the annular planar portion is deformed.

The support member is made of a metal such as iron, stainless steel, or the like, and formed by using, for example, a plate material having a thickness from approximately 1 to 2 mm.

When the annular surface portion is an annular planar portion, the annular surface portion is formed from a flat surface. When the annular surface portion includes a deformed portion in which all or a part of at least one of the inner peripheral portion and the outer peripheral portion of the annular planar portion is deformed, the annular surface portion can be used in the forms described below.

The annular surface portion including a deformed portion bent in one direction from the inner peripheral portion of the annular planar portion.

The annular surface portion including a deformed portion bent in one direction from the outer peripheral portion of the annular planar portion.

The annular surface portion including a deformed portion bent in the same direction or a different direction from both the inner peripheral portion and the outer peripheral portion of the annular planar portion.

The annular surface portion including a deformed portion in which a portion including the outer peripheral portion of the annular planar portion is deformed in the thickness direction.

The deformed portion may be a portion that is extended in a direction perpendicular to the annular planar portion, may be a portion that is extended in a diagonal direction, or the deformed portion may be a flat surface or a stepped surface.

A part of the support member including the outer peripheral portion of the annular surface portion is arranged abutting against the annular protruding wall surface of the plurality of independent protrusions or the first annular protruding wall surface of the annular protrusion.

When the annular surface portion includes only the annular planar portion, a part of the support member including the outer peripheral portion of the annular planar portion is arranged abutting against the annular protruding wall surface of the plurality of independent protrusions or the first annular protruding wall surface of the annular protrusion.

When, in the annular surface portion, the outer peripheral portion of the annular planar portion is bent in one direction, the bent portion of the support member is arranged abutting against the annular protruding wall surface of the plurality of independent protrusions or the first annular protruding wall surface of the annular protrusion.

As for the cylindrical filter, a second annular end surface is supported by a support member, and a first annular end surface is supported by or abutting against an inner wall surface of the housing that faces the annular surface portion of the support member in an axial direction. It is noted that the first annular end surface may be indirectly abutting against the inner wall surface of the housing with a sealing member or the like interposed therebetween.

The cylindrical filter need not be press-fitted against the housing and may be arranged in a manner that a gap is formed between the outer peripheral wall surface of the cylindrical filter and the inner wall surface of the housing. As a result, a filtering and cooling function is exhibited throughout the cylindrical filter.

Note that the sealing agent can be applied to the annular surface portion in advance to increase the sealing performance of the contact portion between the support member and the second annular end surface of the cylindrical filter, and thus to prevent short paths of the combustion gas. The short path of the combustion gas in the present invention refers to the flow of combustion gas to the gas discharge port through a contact portion between the second annular end surface of the cylindrical filter and a member supporting the cylindrical filter without flowing through the cylindrical filter.

The inner wall surface of the housing that faces the annular surface portion of the support member in an axial direction corresponds to, for example, in the case of a disk-shaped housing, a top plate that axially faces a bottom plate to which an igniter is fixed, and in the case of a cylinder-shaped housing in which an igniter is arranged on one end side and a diffuser portion including a gas discharge port is provided on the other end side, when the diffuser portion has cup-shaped, includes the gas discharge port on a peripheral wall surface, and includes a closed end surface, the inner wall surface of the housing corresponds to the closed end surface.

In a preferred aspect (a third aspect) of the gas generator of the first aspect, the annular surface portion of the support member includes an annular planar portion, an outer annular wall surface portion extending in one direction from the outer peripheral portion of the annular planar portion, and an inner annular wall surface portion extending from the inner peripheral portion of the annular planar portion in the opposite direction to the outer annular wall surface portion along the axis of the housing,

an outer surface of the outer annular wall surface portion is abutting against an inner wall surface of the housing, and an annular end surface that is a tip of the outer annular wall surface portion is abutting against the annular protruding wall surface of the plurality of independent protrusions or a first annular protruding wall surface of the annular protrusion, and

the cylindrical filter is arranged in a state in which the second annular end surface is abutting against the annular planar portion, a portion of the inner peripheral wall surface is abutting against the inner annular wall surface portion, and the entire surface of the first annular end surface is abutting against the inner wall surface of the housing facing the annular planar portion in an axial direction.

The annular surface portion of the support member used in the third aspect includes an outer annular wall surface portion and an inner annular wall surface portion as deformed portions in which a part of the annular planar portion is deformed.

The angle between the annular planar portion and the outer annular wall surface portion or the inner annular wall surface portion is preferably 90 degrees or close to 90 degrees.

The length of the outer annular wall surface portion and the inner annular wall surface portion from the annular planar portion may be the same or different, but the length of the outer annular wall surface portion is preferably longer than the length of the inner annular wall surface portion.

Since the inner annular wall surface portion is abutting against a part of the inner peripheral wall portion of the cylindrical filter, if the area of the contact portion is too large, the filtration and cooling function get degraded, and therefore, a very large contact portion area is not preferable.

When a support member having a specific shape according to the third aspect is used, the space between the inner wall surface of the housing including the gas discharge port and the cylindrical filter increases.

In addition, since the support member having a specific shape according to the third aspect includes an inner annular wall surface portion, a short path of the combustion gas from the contact portion between the second annular end surface of the cylindrical filter and the annular planar portion of the support member can be prevented.

In another preferable aspect (a fourth aspect) of the gas generator of the first aspect, the cylindrical filter is supported by a combination of the support member including the annular surface portion and a retainer,

the support member includes only an annular planar portion, and a part of an outer peripheral portion side of the annular planar portion is abutting against the annular protruding wall surface of the plurality of independent protrusions or the first annular protruding wall surface of the annular protrusion,

the retainer includes an annular plate portion and an outer annular portion extending in one direction from an outer peripheral portion of the annular plate portion,

the annular plate portion of the retainer is abutting against the annular planar portion of the support member, and the outer annular portion of the retainer is abutting against the inner wall surface of the housing, and

the cylindrical filter is arranged in a state in which the second annular end surface is abutting against the annular plate portion of the retainer, the outer peripheral wall surface is abutting against the outer annular portion of the retainer, and an entire surface of the first annular end surface is abutting against an inner wall surface of the housing facing the annular planar portion of the support member in an axial direction.

In the fourth aspect, by combining the support member and the retainer, the retainer is supported by the support member, and the cylindrical filter is supported by the retainer. By using a retainer having a specific shape, a short path of the combustion gas from between the retainer and the second annular end surface of the cylindrical filter can be prevented.

In another preferred aspect (a fifth aspect) of the gas generator of the first aspect, a width (W1) of the first annular end surface of the cylindrical filter is greater than a width (W2) of the second annular end surface of the cylindrical filter (W1>W2), and an inclined surface is formed at the inner peripheral wall surface at a side of the second annular end surface.

Since the combustion chamber of the gas generator is on an inner side of the cylindrical filter, when the gas generating agent is filled in the combustion chamber, the gas generating agent is filled from the side of the first annular end surface of the cylindrical filter. At this time, if the side of the second annular end surface is an inclined surface, it is easier to fill the gas generating agent to a side lower than the second annular end surface, and is thus preferable.

In another preferred aspect (a sixth aspect) of the gas generator of the first aspect, the arrangement state of the plurality of independent protrusions or the annular protrusion, and the support member including the annular surface portion for supporting the cylindrical filter satisfies at least one of the requirement (I), requirement (II), and requirement (III) below.

(I): A height H1 from the inner wall surface of the housing to the tip surface of the plurality of independent protrusions or the annular tip surface of the annular protrusion, and a length L1 of a contact portion between the annular protruding wall surface of the plurality of independent protrusions or the first annular protruding wall surface of the annular protrusion and the support member satisfy the relationship 0.4≤L1/H1<1.

(II): An angle R of the boundary between the annular protruding wall surface and the tip surface, or the boundary between the first annular protruding wall surface and the annular tip surface is in a range from 1 to 3 mm.

(III): A thickness (t1) of the plurality of independent protrusions or the annular protrusion and a thickness (t2) of a contact portion of the support member that is a portion in contact with the plurality of independent protrusions or the annular protrusion satisfy the relationship t2≥t1.

Requirement (I) requires that the relationship 0.4≤L1/H1<1 is satisfied. In a case where the annular surface portion of the support member includes only the annular planar portion, the part near the outer peripheral portion of the annular planar portion is abutting against the annular protruding wall surface of the plurality of independent protrusions or the first annular protruding wall surface of the annular protrusion, and therefore, L1 is the length of the contact portion.

When the annular surface portion of the support member includes an annular planar portion, an outer annular wall surface portion extending in one direction from an outer peripheral portion of the annular planar portion, and an inner annular wall portion extending from an inner peripheral portion of the annular planar portion in the opposite direction to the outer annular wall surface portion along the axis of the housing (third aspect), the annular end surface of the outer annular wall surface portion is abutting against the annular protruding wall surface of the plurality of independent protrusions or the first annular protruding wall surface of the annular protrusion, and therefore, L1 is the thickness of the annular end surface of the outer annular wall surface portion.

By satisfying requirement (I), the annular surface portion of the support member is easily supported by the plurality of independent protrusions or the annular protrusion.

As for requirement (II), it is necessary for angle R to be in a range from 1 to 3 mm. By satisfying requirement (II), the load of both the support member and the cylindrical filter is easily supported by the plurality of independent protrusions or the annular protrusion.

Requirement (III) requires that the thickness (t1) of the plurality of independent protrusions or the annular protrusion and the thickness (t2) of a contact portion of the support member that is a portion in contact with the plurality of independent protrusions or the annular protrusion satisfy the relationship t2≥t1. When the contact portion is the annular planar portion, the thickness (t2) of the contact portion is the thickness of the annular planar portion, and when the contact portion is the annular end surface of the outer annular wall surface portion, the thickness (t2) of the contact portion is the thickness of the outer annular wall surface portion. By satisfying requirement (III), the cylindrical filter is easily supported by the support member.

In another preferred aspect (a seventh aspect) of the gas generator of the first aspect, the annular surface portion of the support member includes an annular planar portion and an outer annular wall surface portion extending in one direction from the outer peripheral portion of the annular planar portion,

a plurality of mating portions are formed in the circumferential direction, the plurality of mating portions being formed from holes extending in both the annular planar portion and the outer annular wall surface portion,

an outer surface of the outer annular wall surface portion is abutting against an inner wall surface of the housing, and each of the plurality of mating portions formed from the holes is mated with each of the plurality of independent protrusions, and

the cylindrical filter is arranged in a state in which the second annular end surface is abutting against the annular planar portion, the outer peripheral wall portion is abutting against the outer annular wall surface portion, and the first annular end surface is abutting against an inner wall surface of the housing facing the annular planar portion in an axial direction.

The seventh aspect is applicable when the housing includes a plurality of independent protrusions, and is not applicable when the housing includes an annular protrusion.

As for the support member according to the seventh aspect, a plurality of mating portions are formed in the circumferential direction, the plurality of mating portions being formed from holes extending in both the annular planar portion and the outer annular wall surface portion, and the plurality of mating portions formed from the holes have a number and position that enables mating with each of the plurality of independent protrusions. Since the mating portions formed from the holes of the support member are thus mated with the independent protrusions, the support strength of the support member with respect to the housing is increased.

In another preferred aspect (an eighth aspect) of the gas generator of the first aspect, the annular surface portion of the support member includes an annular planar portion and a plurality of semicircular-shaped convex portions formed in the circumferential direction in the outer peripheral portion of the annular planar portion,

the semicircular-shaped convex portions are formed by deforming, in a thickness direction, a portion of the annular planar portion including the outer peripheral portion,

each of the plurality of semicircular-shaped convex portions of the annular planar portion is mated with each of the plurality of independent protrusions, and

the cylindrical filter is arranged in a state in which the second annular end surface is abutting against the annular planar portion, and the first annular end surface is abutting against the inner wall surface of the housing facing the annular planar portion in an axial direction.

The eighth aspect is applicable when the housing includes a plurality of independent protrusions, and is not applicable when the housing includes an annular protrusion.

The support member according to the eighth aspect includes an annular planar portion and a plurality of semicircular-shaped convex portions formed in the circumferential direction in the outer peripheral portion of the annular planar portion, and the semicircular-shaped convex portions are formed by deforming, in a thickness direction, a portion of the annular planar portion including the outer peripheral portion. Each of the plurality of semicircular-shaped convex portions has a number and position that enables mating with each of the plurality of independent protrusions. Since the semicircular-shaped convex portions of the support member are thus mated with the independent protrusions, the support strength of the support member with respect to the housing is increased.

The eighth aspect is applicable to a gas generator including a disk-shaped housing.

According to the eighth aspect, the cylindrical filter is supported by combining a cylindrical member and a support member. Since the support member is supported by both the protrusion of the cylindrical member and the cup member, and the cylindrical filter is supported by both the support member and the cylindrical member, it is possible to provide support with a high support strength.

In the gas generator according to the present invention, since the filter is supported by using a support member arranged inside the housing, the same filter used in a known gas generator can be used.

In addition, in the gas generator according to the present invention, since the filter is supported by using a support member arranged inside the housing, a special method such as press-fitting or the like need not be used when the filter is arranged, which makes the work easy.

Furthermore, in the gas generator according to the present invention, since the filter is supported by using a support member arranged inside the housing, a space can be formed between the filter and the wall surface of the housing including the gas discharge port, and the entire filter can be used for filtering and cooling the combustion gas.

The gas generator according to the present invention can be used as a gas generator for an airbag device mounted in an automobile, or the like.

### Embodiments of the Invention

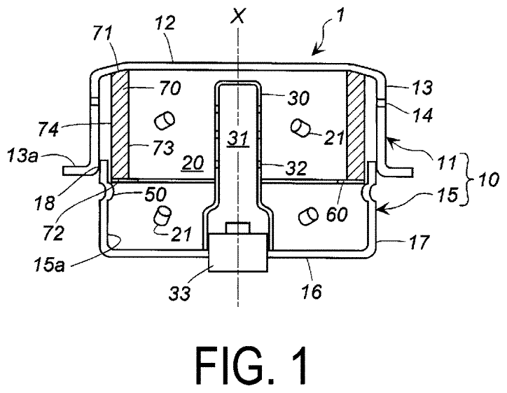

### 1. Gas Generator in FIG. 1

A gas generator 1 includes a housing 10 including a diffuser shell 11 and a closure shell 15. The housing 10 illustrated in FIG. 1 has a circular shape in plane view, but is not limited thereto.

The diffuser shell 11 includes a top plate 12 and a first peripheral wall portion 13 extending from the top plate 12, and includes a flange portion 13a in an opening. A plurality of gas discharge ports 14 are formed in the first peripheral wall portion 13 at intervals in the circumferential direction, which are closed from the inner side with a metallic sealing tape (not illustrated) with the purpose of damp-proofing.

The closure shell 15 includes a bottom plate 16 and a second peripheral wall portion 17 extending from the bottom plate 16.

An igniter 33 is mounted on the bottom plate 16, and the igniter 33 is covered with an ignition means chamber cup 30 including a number of fire transfer holes 32. Inside the ignition means chamber cup 30 is an ignition means chamber 31 that accommodates a transfer charge or a gas generating agent that acts as a transfer charge, which is not illustrated.

The housing 10 is formed by the closure shell 15 being fitted in the inner side of the diffuser shell 11, and a contact portion 18 being welded.

On the inner side of the housing 10 is a combustion chamber 20 containing the gas generating agent 21, and a cylindrical filter 70 is arranged between the gas discharge port 14 and the combustion chamber 20.

The cylindrical filter 70 includes a first annular end surface 71, a second annular end surface 72 on the opposite side of the first annular end surface 71 in the X-axis direction, an inner peripheral wall surface 73, and an outer peripheral wall surface 74.

The closure shell 15 includes a plurality of independent protrusions 50 protruding inwardly from the inner wall surface 15a. It is preferable that, as the plurality of independent protrusions 50, 3 to 12 independent protrusions 50 are formed at equal intervals in the circumferential direction of the second peripheral wall portion 17, and it is more preferable that 3 to 8 independent protrusions 50 are formed. The plurality of independent protrusions 50 are positioned closer to the bottom plate 16 from the contact portion 18.

The independent protrusions 50 include an annular protruding wall surface 51 and a tip surface 52 surrounded by an annular protruding wall surface 51. The angle portion of a boundary 53 between the annular protruding wall surface 51 and the tip surface 52 is roundish.

The independent protrusions 50 can be formed by a method of embossing from the outer side of the housing 10, or a method of mounting another member on the inner wall surface 15a of the closure shell 15 by welding or another method.

A support member 60 made of metal for supporting the cylindrical filter 70 is arranged inside the housing 10. The metal support member 60 made of metal includes only an annular planar portion 61 including an inner peripheral portion 62 and an outer peripheral portion 63.

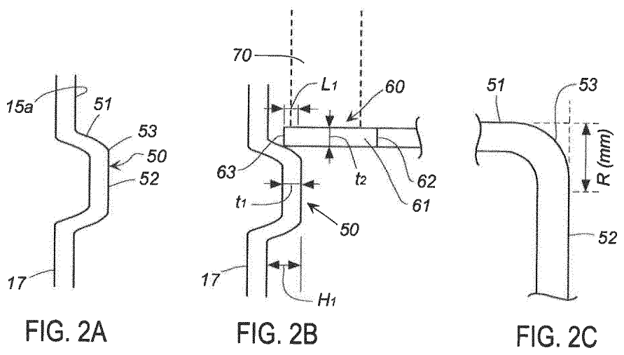

As illustrated in FIG. 2B, a part of the support member 60 including the outer peripheral portion 63 of the annular planar portion 61 is abutting against the top plate 12 side of the annular protruding wall surface 51 of the independent protrusions 50.

The cylindrical filter 70 is arranged in a state in which an entire surface of the second annular end surface 72 is abutting against the annular planar portion 61 of the support member 60, and the entire surface of the first annular end surface 71 is abutting against the top plate 12 of the housing that faces the annular planar portion 61 in the X-axis direction. It is noted that other members may be interposed between the first annular end surface 71 and the top plate 12 to compress the cylindrical filter 70 in an axial direction. Furthermore, the outer peripheral wall surface 74 of the cylindrical filter 70 is abutting against the inner wall surface 15a of the closure shell 15 at the top plate 12 side from the independent protrusions 50. It is noted that, to improve the function of preventing short paths of the combustion gas, a sealing agent can be applied or a sealing material can be interposed in the contact portion between the annular planar portion 61 and the second annular end surface 72. The cylindrical filter 70 is supported from both sides in the X-axis direction by both the annular planar portion 61 of the support member and the top plate 12, and is positioned and fixed by being supported by the inner wall surface 15a of the closure shell 15 from the outer side in the radial direction.

In the gas generator 1 illustrated in FIG. 1, the arrangement state of the plurality of independent protrusions and the support member satisfies the requirement (I), requirement (II), and requirement (III) below.

Requirement (I): Since the ratio (L1/H1) of the height H1 from the inner wall surface 15a of the closure shell up to the tip surface 52 of the independent protrusions, and the length L1 of the contact portion between the annular protruding wall surface 51 of the independent protrusions and the support member 60 is 0.6, the relationship 0.4≤L1/H1<1 is satisfied.

Requirement (II): Since the angle R (see FIG. 2C) of the boundary 53 of the annular protruding wall surface 51 and the tip surface 52 is 2 mm, the relationship angle R=1 to 3 mm is satisfied.

Requirement (III): Since the ratio (t2/t1) of the thickness (t1) of the housing in which the plurality of independent protrusions 50 are formed, and the thickness (t2) of the support member 60 is 1.2, the relationship t2≥t1 is satisfied.

When any of the requirements (I) to (III) is thus satisfied, the support member 60 is less likely to fall out of the independent protrusions 50. Preferably, all of (I) to (III) are satisfied.

Note that, when the contact portion 18 of the diffuser shell 11 and the closure shell 15 is welded after being assembled in the state illustrated in FIG. 1, the cylindrical filter 70 is positioned on the inner side of the contact portion (welded portion) 18, which is preferable because the heat during welding is less likely to be transferred into the combustion chamber 20.

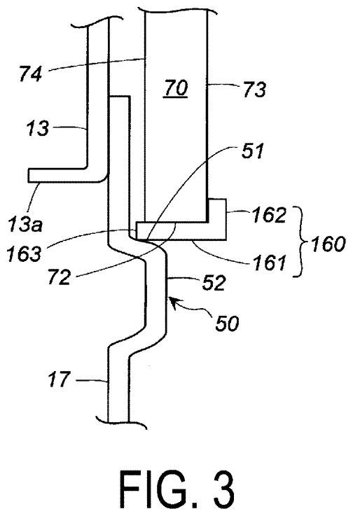

### 2. Gas Generator Having a Partial Structure Illustrated in FIG. 3

Since the gas generator having the partial structure illustrated in FIG. 3 is the same as the gas generator 1 illustrated in FIG. 1 except for the structure illustrated in FIG. 3, the gas generator will be described through FIG. 1, and only the portion different from that illustrated in FIG. 1 will be described through FIG. 3.

A support member 160 in FIG. 3 includes an annular planar portion 161 and an inner annular wall surface portion 162 extending from the inner peripheral portion of the annular planar portion 161 in the direction of the top plate 12. Since the support member 160 includes the inner annular wall surface portion 162, as compared with the case of only the annular planar portion 161, deformation is less likely to occur with respect to the force from both sides in the X-axis direction. Therefore, although the requirements (I) to (III) are also satisfied in FIG. 3, in terms of the thickness of the annular planar portion 161, the thickness t2 can be made smaller even when the thickness of the annular planar portion 60 illustrated in FIG. 1 and FIG. 2B satisfies the relationship t2>t1.

As illustrated in FIG. 3, a part of the support member 160 including the outer peripheral portion 163 of the annular planar portion 161 is abutting against the annular protruding wall surface 51 of the independent protrusions 50.

The cylindrical filter 70 is arranged in a state in which an entire surface of the second annular end surface 72 is abutting against the annular planar portion 161 of the support member 160, and the entire surface of the first annular end surface 71 is abutting against the top plate 12 of the housing that faces the annular planar portion 161 in the X-axis direction. Since the second annular end surface 72 side of the inner peripheral wall surface 73 of the cylindrical filter 70 is abutting against the inner annular wall surface portion 162, the function of preventing short paths of combustion gas is improved together with the positioning of the cylindrical filter 70, and a sealing member is not required for improving the function of preventing short paths.

The cylindrical filter 70 is supported from both sides in the X-axis direction by both the annular planar portion 161 of the support member and the top plate 12, and is positioned and fixed by being supported by the inner annular wall surface portion 162 of the support member 160 from the inner side in the radial direction.

The support member 160 includes the annular planar portion 161 and the inner annular wall surface portion 162, and since a space can be secured between the outer peripheral wall surface 74 of the cylindrical filter 70 and the inner wall surfaces of the diffuser shell 11 and the closure shell 15, the cooling efficiency of the cylindrical filter 70 is improved, which is preferable.

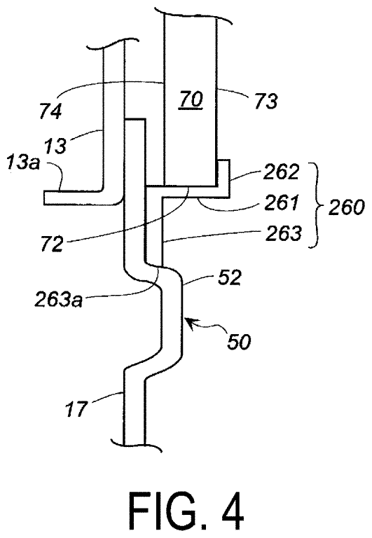

### 3. Gas Generator Having a Partial Structure Illustrated in FIG. 4

Since the gas generator having the partial structure illustrated in FIG. 4 is the same as the gas generator 1 illustrated in FIG. 1 except for the structure illustrated in FIG. 4, the gas generator will be described through FIG. 1, and only the portion different from that illustrated in FIG. 1 will be described through FIG. 4.

A support member 260 in FIG. 4 includes an annular planar portion 261, an outer annular wall surface portion 263 extending from the outer peripheral portion of the annular planar portion 261 toward the bottom plate 16, and an inner annular wall surface portion 262 extending from the inner peripheral portion of the annular planar portion 261 toward the top plate 12, as opposed to the outer annular wall surface portion 263. Since the support member 260 includes the inner annular wall surface portion 262 and the outer annular wall surface portion 263, as compared with the case of only the annular planar portion 261, deformation is less likely to occur with respect to the force applied upwardly or downwardly along the X-axis direction. Therefore, although the requirements (I) to (III) are also satisfied in FIG. 4, in terms of the thickness of the annular planar portion 261, the thickness t2 can be made smaller even when the thickness of the annular planar portion 60 illustrated in FIG. 1 and FIG. 2B satisfies the relationship t2>t1.

As illustrated in FIG. 4, in the support member 260, the outer surface of the outer annular wall surface portion 263 is abutting against the inner wall surface of the second peripheral wall portion 17 of the closure shell 15, and the annular end surface 263a that is a tip of the outer annular wall surface portion 263 is abutting against the top plate 12 side of the annular protruding wall surface 51 of the independent protrusions 50.

The cylindrical filter 70 is arranged in a state in which the second annular end surface 72 is abutting against the annular planar portion 261, a part of the inner peripheral wall portion 73 at the second annular end surface 72 side is abutting against the inner annular wall surface portion 262, and the entire surface of the first annular end surface 71 is abutting against the top plate 12. Since a part of the inner peripheral wall portion 73 of the cylindrical filter 70 is abutting against the inner annular wall surface portion 262, the function of preventing short paths of combustion gas is improved together with the positioning of the cylindrical filter 70, and a sealing member is not required for improving the function of preventing short paths.

The cylindrical filter 70 is supported from both sides in the X-axis direction by both the annular planar portion 261 of the support member and the top plate 12, and is positioned and fixed by being supported by the inner annular wall surface portion 262 of the support member 260 from the inner side in the radial direction.

The support member 260 includes the annular planar portion 261, the inner annular wall surface portion 262, and the outer annular wall surface portion 263, and since a space can be secured between the outer peripheral wall surface 74 of the cylindrical filter 70 and the inner wall surfaces of the diffuser shell 11 and the closure shell 15, the cooling efficiency of the cylindrical filter 70 is improved, which is preferable.

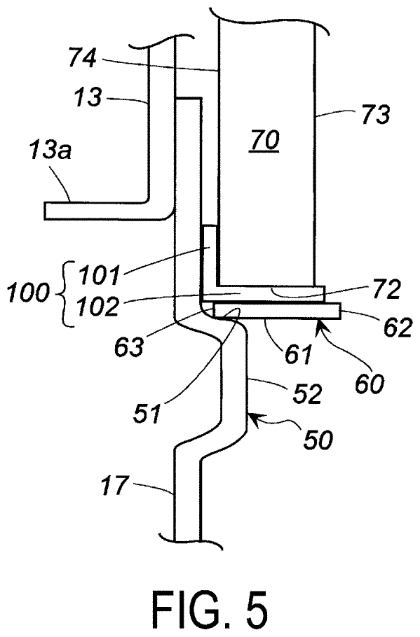

### 4. Gas Generator Having a Partial Structure Illustrated in FIG. 5

Since the gas generator having a partial structure illustrated in FIG. 5 is the same as the gas generator 1 illustrated in FIG. 1 except for the structure illustrated in FIG. 5, the gas generator will be described through FIG. 1, and only the portion different from that illustrated in FIG. 1 will be described through FIG. 5.

In the embodiment according to FIG. 5, the cylindrical filter 70 is supported by a combination of the support member 60 including the same annular planar portion 61 as that illustrated in FIG. 1 and a retainer 100.

The retainer 100 includes an annular plate portion 102 and an outer annular portion 101 extending from the outer peripheral portion of the annular plate portion 102 toward the top plate 12.

A part of the annular planar portion 61 of the support member 60 which is near outer peripheral portion 63 is abutting against the annular protruding wall surface 51 of the plurality of independent protrusions 50.

In the retainer 100, the outer annular portion 101 is press-fitted in to the inner wall surface 15a of the second peripheral wall portion 17 of the closure shell 15, and the annular plate portion 102 is abutting against the annular planar portion 61 of the support member 60. Therefore, the outer annular portion 101 and the inner wall surface of the second peripheral wall portion 17 are in a close-contact state.

The cylindrical filter 70 is arranged in a state in which the second annular end surface 72 is abutting against the annular plate portion 102 of the retainer 100, a part of the outer peripheral wall portion 74 at the second annular end surface 72 side is abutting against the outer annular portion 101, and the entire surface of the first annular end surface 71 is abutting against the top plate 12. Since a part of the outer peripheral wall portion 74 of the cylindrical filter is abutting against the outer annular portion 101, the function of preventing short paths of combustion gas is improved together with the positioning of the cylindrical filter 70. It is noted that a sealing member is not required for improving the function of preventing short paths.

The cylindrical filter 70 is supported from both sides in the X-axis direction by both the retainer 100 and the top plate 12, and is positioned and fixed by being supported by the outer annular portion 101 of the retainer 100 from the outer side of the radial direction.

With the retainer 100, since as much space as the thickness of the outer annular portion 101 can be secured between the outer peripheral wall surface 74 of the cylindrical filter 70 and the inner wall surfaces of the diffuser shell 11 and the closure shell 15, the cooling efficiency of the cylindrical filter 70 is improved, which is preferable.

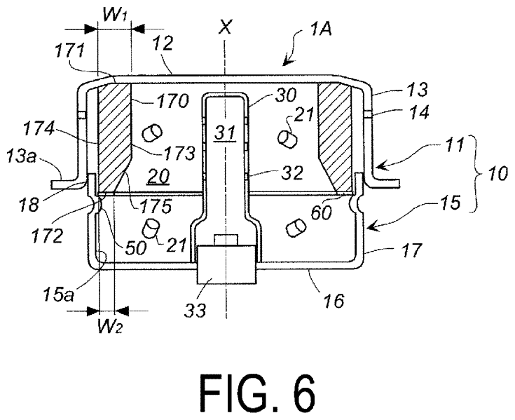

### 5. Gas Generator Illustrated in FIG. 6

The gas generator 1A in FIG. 6 is the same as the gas generator 1 illustrated in FIG. 1 except that the shape of the filter is different, and therefore, only the portions that are different will be described.

The cylindrical filter 170 includes a first annular end surface 171, a second annular end surface 172 on the opposite side in the X-axis direction (at the bottom plate 16 side), an inner peripheral wall surface 173, and an outer peripheral wall surface 174. The width (W1) of the first annular end surface 171 is greater than the width (W2) of the second annular end surface 172 (W1>W2), and an annular inclined surface 175 is formed on the inner peripheral wall surface 173 at the second annular end surface 172 side due to the difference in the width of both end surfaces.

The cylindrical filter 170 is arranged in a state in which the entire surface of the second annular end surface 172 is abutting against the annular planar portion 61 of the support member 60, and the entire surface of the first annular end surface 171 is abutting against the top plate 12 of the housing. Furthermore, the outer peripheral wall surface 174 of the cylindrical filter 170 is abutting against the inner wall surface 15a of the second peripheral wall portion at the top plate 12 side from the independent protrusions 50. Note that, to improve the function of preventing short paths of the combustion gas, a sealing agent can be applied or a gasket, etc. can be arranged in the contact portion between the annular planar portion 61 and the second annular end surface 172.

The cylindrical filter 170 is supported from both sides in the X-axis direction by both the annular planar portion 61 of the support member and the top plate 12, and is positioned and fixed by being supported by the inner wall surface 15a of the second peripheral wall portion from the outer side in the radial direction.

Note that the support member 60 has a slightly smaller width than the support member 60 illustrated in FIG. 1 in accordance with the width of the second annular end surface 172 of the cylindrical filter 170, to which the support member 60 is abutting against.

The effect of using the cylindrical filter 170 including the annular inclined surface 175 will be described while describing the method of assembling the gas generator 1A illustrated in FIG. 6.

First of all, an igniter 33 and an ignition means chamber cup 30 containing a transfer charge are mounted on the closure shell 15. Next, after the support member 60 is placed on the protrusion 50, the cylindrical filter 170 is placed on the support member 60.

Following this, a required amount of the gas generating agent 21 is introduced from the opening at the first annular end surface 171 side of the cylindrical filter 170. At this time, if a cylindrical filter 170 with a uniform width as illustrated in FIG. 1 and a relatively higher thickness is used, the gas generating agent 21 is less likely to enter directly below the second annular end surface 172 (support member 60). Thus, it is necessary to perform an operation such as applying vibrations to the closure shell 15. But, since the cylindrical filter 170 is not fixed at this stage, this is an extremely difficult operation to perform.

However, when the cylindrical filter 170 including the annular inclined surface 175 as illustrated in FIG. 6 is used, the gas generating agent is easily introduced even directly below the second annular end surface 172 (support member 60), because of which the entire gas generating agent can be easily accommodated.

Next, the diffuser shell 11 is covered, and the contact portion 18 between the diffuser shell 11 and the closure shell 15 is welded. At this time, since the cylindrical filter 170 is positioned on the inner side of the contact portion 18, the heat during welding is less likely to be transferred inside the combustion chamber 20.

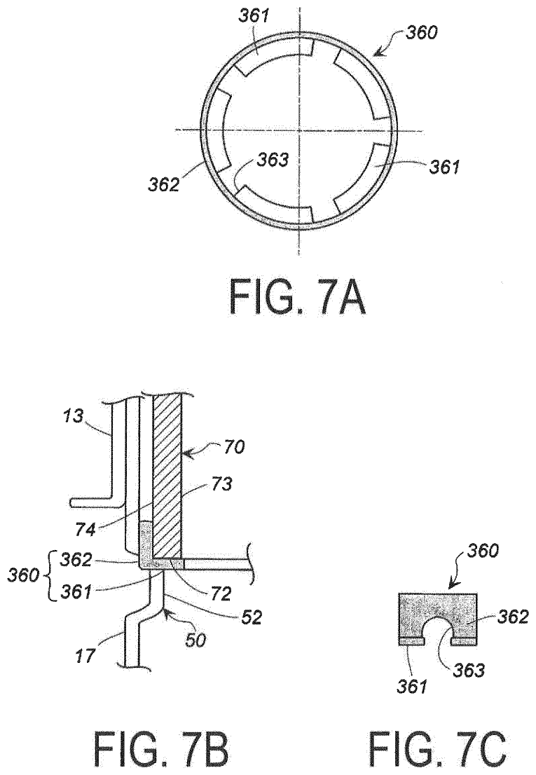

### 6. Gas Generator Having a Partial Structure Illustrated in FIGS. 7A, 7B and 7C

Since the gas generator having the partial structure illustrated in FIG. 7A to 7C is the same as the gas generator 1 illustrated in FIG. 1 except for the structure illustrated in FIGS. 7A, 7B, and 7C, the gas generator will be described through FIG. 1, and only the portion different from that illustrated in FIG. 1 will be described through FIGS. 7A, 7B, and 7C.

A support member 360 includes an annular planar portion 361 and an outer annular wall surface portion 362 extending from the outer peripheral portion of the annular planar portion 361 in the direction of the top plate 12. Furthermore, in the support member 360, a plurality (five in FIG. 7A) of mating portions 363 formed by holes extending in both the annular planar portion 361 and the outer annular wall surface portion 362 are formed at equal intervals in the circumferential direction.

As illustrated in FIGS. 7B and 7C, the outer surface of the outer annular wall surface portion 362 of the support member 360 is abutting against the inner wall surface of the second peripheral wall portion 17 of the closure shell 15, and the mating portions 363 are mated with a total of five independent protrusions 50. The mating portions 363 are supported in the X-axis direction and the radial direction by being mated with the annular protruding wall surface 51 of the independent protrusion 50 from the top plate 12 side.

The cylindrical filter 70 is arranged in a state in which the second annular end surface 72 is abutting against the annular planar portion 361, the outer peripheral wall portion 74 close to the second annular end surface 72 is abutting against the outer annular wall surface portion 362, and the first annular end surface 71 is abutting against the housing top plate 12. Since a part of the outer peripheral wall portion 74 of the cylindrical filter is abutting against the outer annular wall surface portion 362, the positioning of the cylindrical filter 70 and the function of preventing short paths of combustion gas are improved, and a sealing member is not required for improving the function of preventing short paths.

The cylindrical filter 70 is supported from both sides in the X-axis direction by both the support member 360 and the top plate 12, and is positioned and fixed by being abutting against the outer annular wall surface portion 362 of the support member 360 from the outer side in the radial direction.

In the support member 360, since as much space as the thickness of the outer annular wall surface portion 362 can be secured between the outer peripheral wall surface 74 of the cylindrical filter 70 and the inner wall surfaces of the diffuser shell 11 and the closure shell 15, the cooling efficiency of the cylindrical filter 70 is improved, which is preferable.

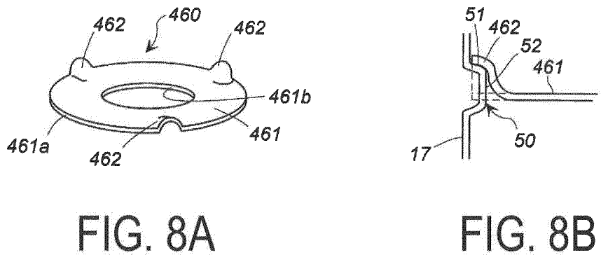

### 7. Gas Generator Having a Partial Structure Illustrated in FIGS. 8A and 8B

Since a gas generator having a partial structure illustrated in FIGS. 8A and 8B is the same as the gas generator 1 illustrated in FIG. 1 except for the structure illustrated in FIGS. 8A and 8B, the gas generator will be described through FIG. 1, and only the portion different from that illustrated in FIG. 1 will be described through FIGS. 8A and 8B.

A support member 460 includes an annular planar portion 461 and a plurality of semicircular-shaped convex portions 462 formed at equal intervals in the circumferential direction in the outer peripheral portion 461a of the annular planar portion 461. In the semicircular-shaped convex portions 462, a portion including the outer peripheral portion 461a of the annular planar portion 461 is deformed by protruding in a semicircular shape in a thickness direction (the direction of the top plate 12 when arranged in the gas generator 1 illustrated in FIG. 1).

The length of the semicircular-shaped convex portions 462 (the distance from the outer peripheral portion 461a to the portion where the convex portions 462 are formed in the inner peripheral portion 461b) is 20% or less, and more preferably 10% or less the width of the annular planar portion 461 (the distance from the outer peripheral portion 461a to the inner peripheral portion 461b).

The semicircular-shaped convex portions 462 is mated with, in a state being in contact with, the annular protruding wall surface 51 and the tip surface 52 of the plurality of independent protrusions 50, and thus the annular planar portion 461 of the support member 460 is supported in the X-axis direction and the radial direction.

The cylindrical filter 70 is arranged in a state in which the second annular end surface 72 is abutting against the annular planar portion 461, and the first annular end surface 71 is abutting against the top plate 12. It is noted that, to improve sealing performance of the contact portion between the annular planar portion 461 and the second annular end surface 72 of the cylindrical filter, and thus prevent short paths, a sealing agent can be applied or a gasket, etc. can be arranged in advance in the annular planar portion 361

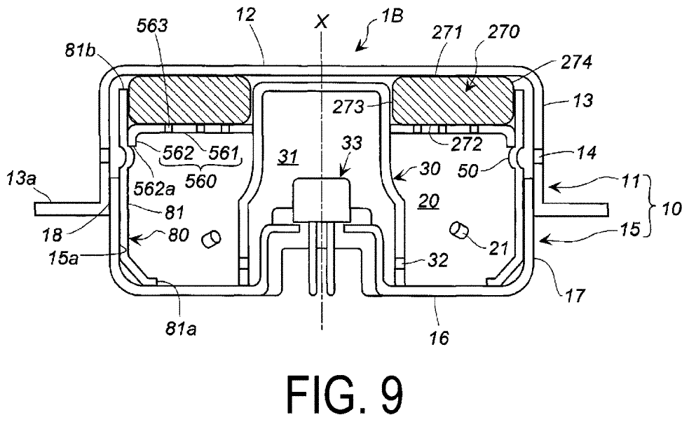

### 8. Gas Generator Illustrated in FIG. 9

A gas generator 1B includes the housing 10 including the diffuser shell 11 and the closure shell 15. The housing 10 illustrated in FIG. 9 has a circular shape in plane view, but is not limited thereto.

The diffuser shell 11 includes the top plate 12 and the first peripheral wall portion 13 extending from the top plate 12, and includes the flange portion 13a in the opening. The plurality of gas discharge ports 14 are formed in the first peripheral wall portion 13 at intervals in the circumferential direction, which are closed from the inner side with a metallic sealing tape (not illustrated) with the purpose of damp-proofing.

The closure shell 15 includes the bottom plate 16 and the second peripheral wall portion 17 extending from the bottom plate 16.

The igniter 33 is mounted on the bottom plate 16, and the igniter 33 is covered with the ignition means chamber cup (a cup member) 30 including a number of fire transfer holes 32. Inside the ignition means chamber cup 30 is the ignition means chamber 31 that accommodates the transfer charge or the gas generating agent that acts as a transfer charge, which is not illustrated.

The housing 10 is formed by the closure shell 15 being fitted in the inner side of the diffuser shell 11, and the contact portion 18 being welded. On the inner side of the housing 10 is the combustion chamber 20 containing the gas generating agent 21, and a cylindrical filter 270 is arranged between the gas discharge port 14 and the combustion chamber 20.

The cylindrical filter 270 includes a first annular end surface 271, a second annular end surface 272 on the opposite side of the first annular end surface 271 in the X-axis direction, an inner peripheral wall surface 273, and an outer peripheral wall surface 274. The cylindrical filter 270 is the same as the cylindrical filter 70 illustrated in FIG. 1 except that the height is lesser.

A cylindrical member 80 and a support member 560 for supporting the cylindrical filter 270 are arranged inside the housing 10. The cylindrical member 80 is press-fitted into the housing 10. The cylindrical member 80 and the support member 560 can be made of metal.

The cylindrical member 80 includes a cylindrical main body portion 81 extending in the X-axis direction, and a plurality of independent protrusions 50 protruding from the inner wall surface of the cylindrical main body portion 81 in the inner direction of the housing 10. The plurality of independent protrusions 50 are the same as those illustrated in FIG. 2A.

The lower end 81a side of the cylindrical main body portion 81 functions to support the cylindrical main body portion 81, and has a shape corresponding to both the boundary between the inner wall surface 15a of the closure shell 15 and the bottom plate 16, and the bottom plate 16 adjacent to the boundary.

The cylindrical main body portion 81 of the cylindrical member 80 is abutting against the second peripheral wall portion 17 of the closure shell 15, and the plurality of independent protrusions 50 of the cylindrical member 80 are formed at a position facing the first peripheral wall portion 13 at intervals in the radial direction.

The lower end 81a side of the cylindrical main body portion 81 is abutting against the bottom plate 16, but the upper end 81b side is not abutting against the top plate 12, and a gap is formed between the upper end 81b side and the top plate 12. It is noted that, to achieve easy fitting of the support member 560 during assembly, the upper end 81b side may be slightly inclined outward in the radial direction to an extent that the gas discharge is not affected.

The support member 560 includes an annular planar portion 561 provided with a plurality of through-holes 563 in the thickness direction, and an annular bent portion 562 that is bent in one direction (the direction of the bottom plate 16) from the outer peripheral portion of the annular planar portion 561.

In the support member 560, the inner peripheral portion of the annular planar portion 561 is abutting against the peripheral wall portion of the cup member 30, and a tip portion 562a of the annular bent portion 562 is abutting against the annular protruding wall surface 51 of the plurality of independent protrusions 50.

The cylindrical filter 270 is arranged in a state in which the outer peripheral wall surface 274 is abutting against the cylindrical main body portion 81 of the cylindrical member 80, the inner peripheral wall surface 273 is abutting against the peripheral wall portion of the cup member 30, the first end surface 271 is abutting against the top plate 12, and the second end surface 272 is abutting against the annular planar portion 561 of the support member 560.

Note that there may be a gap between the cylindrical main body portion 81 and the outer peripheral wall surface 274. Furthermore, a plurality of through-holes for allowing the passage of gas that has passed through the cylindrical filter 270 may be formed, if necessary, in the cylindrical main body portion 81 of the cylindrical member 80 with which the outer peripheral wall surface 274 is abutting against.

In the gas generator 1B illustrated in FIG. 9, as with the embodiment illustrated in FIG. 4, the arrangement of the plurality of independent protrusions 50 and the support member 560 satisfies the requirement (I), requirement (II), and requirement (III).

The present invention has been described as above. Of course, the present invention includes various forms of modifications within the scope thereof, and these modifications do not depart from the scope of the invention. All of what a person with ordinary skill in the art will clearly consider as a variation of the present invention is within the scope of the claims set forth below.

1. (canceled)

2. A gas generator, comprising:
a housing made of metal and forming a combustion chamber therein;
a plurality of independent protrusions or an annular protrusion protruding inwardly from an inner wall surface of the housing;
a cylindrical filter which includes a first annular end surface and a second annular end surface opposite the first annular end surface in an axial direction being arranged in the housing; and
a metal support member being arranged inside the housing and including only an annular planar portion, or an annular planar portion and a deformed portion for which all or a part of at least one of an inner peripheral portion and an outer peripheral portion of the annular planar portion is deformed, the support member being configured such that a part of the support member including the outer peripheral portion of the annular planar portion is arranged abutting against the plurality of independent protrusions or the annular protrusion, that the annular planar portion of the support member supports the second annular end surface of the cylindrical filter, and that the first annular end surface of the cylindrical filter is arranged in a state of being supported by an inner wall surface of the housing facing the annular planar portion in an axial direction.

3. The gas generator according to claim 1, wherein
the annular planar portion includes an outer annular wall surface portion extending in one direction from the outer peripheral portion of the annular planar portion, and an inner annular wall surface portion extending from the inner peripheral portion of the annular planar portion in the opposite direction to the outer annular wall surface portion along an axis of the housing,
an outer surface of the outer annular wall surface portion is abutting against the inner wall surface of the housing, and an annular end surface that is a tip of the outer annular wall surface portion is abutting against the plurality of independent protrusions or the annular protrusion, and
the cylindrical filter is arranged in a state in which the second annular end surface thereof is abutting against the annular planar portion, a portion of the inner peripheral wall surface thereof is abutting against the inner annular wall surface portion, and the entire surface of the first annular end surface thereof is abutting against an inner wall surface of an housing facing the annular planar portion in an axial direction.

4. The gas generator according to claim 1, wherein
the cylindrical filter is supported by a combination of the support member including the annular planar portion and a retainer,
the support member includes only an annular planar portion, and a part of an outer peripheral portion side of the annular planar portion is abutting against the plurality of independent protrusions or the annular protrusion,
the retainer includes an annular plate portion and an outer annular portion extending in one direction from an outer peripheral portion of the annular plate portion,
the annular plate portion of the retainer is abutting against the annular planar portion of the support member, and the outer annular portion of the retainer is abutting against the inner wall surface of the housing, and
the cylindrical filter is arranged in a state in which the second annular end surface thereof is abutting against the annular plate portion of the retainer, the outer peripheral wall surface thereof is abutting against the outer annular portion of the retainer, and an entire surface of the first annular end surface thereof is abutting against an inner wall surface of the housing facing the annular planar portion of the support member in an axial direction.

5. The gas generator according to claim 1, wherein
a width (W1) of the first annular end surface of the cylindrical filter is greater than a width (W2) of the second annular end surface of the cylindrical filter (W1>W2), and an inclined surface is formed at an inner peripheral wall surface at a side of the second annular end surface.

6. The gas generator according to claim 1, wherein
the plurality of independent protrusions includes an annular protruding wall surface and a tip surface surrounded by the annular protruding wall surface or,
the annular protrusion includes an annular tip surface, a first annular protruding wall surface and a second annular protruding wall surface, the first annular protruding wall surface and the second annular protruding wall surface each extending, from both sides of the annular tip surface in the width direction, to inner wall surface of the housing,
an arrangement state of the plurality of independent protrusions or the annular protrusion, and the support member including the annular planar portion for supporting the cylindrical filter satisfies at least one of the requirement (I), requirement (II), and requirement (III) below:
(I): A height H1 from the inner wall surface of the housing to the tip surface of the plurality of independent protrusions or the annular tip surface of the annular protrusion, and a length L1 of a contact portion between the annular protruding wall surface of the plurality of independent protrusions or the first annular protruding wall surface of the annular protrusion and the support member satisfy the relationship 0.4≤L1/H1<1;
(II): An angle R of a boundary between the annular protruding wall surface and the tip surface, or a boundary between the first annular protruding wall surface and the annular tip surface is in a range from 1 to 3 mm;
(III): A thickness (t1) of the plurality of independent protrusions or the annular protrusion and a thickness (t2) of the contact portion of the support member that is a portion in contact with the plurality of independent protrusions or the annular protrusion satisfy the relationship t2≥t1.

7. The gas generator according to claim 1, wherein
the annular planar portion includes an outer annular wall surface portion extending in one direction from the outer peripheral portion of the annular planar portion,
a plurality of mating portions are formed in a circumferential direction, the plurality of mating portions being formed from holes extending in both the annular planar portion and the outer annular wall surface portion,
an outer surface of the outer annular wall surface portion is abutting against the inner wall surface of the housing, and each of the plurality of mating portions formed from the holes is mated with each of the plurality of independent protrusions, and
the cylindrical filter is arranged in a state in which the second annular end surface thereof is abutting against the annular planar portion, the outer peripheral wall portion thereof is abutting against the outer annular wall surface portion, and the first annular end surface thereof is abutting against an inner wall surface of the housing facing the annular planar portion in an axial direction.

8. The gas generator according to claim 1, wherein
the annular planar portion includes a plurality of semicircular-shaped convex portions formed in a circumferential direction in the outer peripheral portion of the annular planar portion,
the semicircular-shaped convex portions are formed by deforming, in a thickness direction, a portion of the annular planar portion including the outer peripheral portion,
each of the plurality of semicircular-shaped convex portions of the annular planar portion is mated with each of the plurality of independent protrusions, and
the cylindrical filter is arranged in a state in which the second annular end surface thereof is abutting against the annular planar portion, and the first annular end surface thereof is abutting against an inner wall surface of the housing facing the annular planar portion in an axial direction.

9. A gas generator, comprising, in a housing made of metal, a combustion chamber containing therein a gas generating agent, a cup member accommodating therein an igniter, and a cylindrical filter arranged between the gas discharge port and the combustion chamber,
the housing including a diffuser shell provided with a top plate portion, a first peripheral wall portion formed with a gas discharge port, and an opening, and a closure shell provided with a bottom plate portion, a second peripheral wall portion, and an opening, the housing being formed by fitting the closure shell into the inner side of the opening of the diffuser shell, and welding the closure shell and the diffuser shell at a contact portion therebetween,
the igniter being fixed to the bottom plate, the cup member covering the bottom plate and accommodating therein the igniter, and a bottom surface portion of the cup member being positioned toward the top plate,
the cylindrical filter including a first annular end surface, a second annular end surface opposite the first annular end surface in an axial direction, an inner peripheral wall surface, and an outer peripheral wall surface,
a cylindrical member made of metal for supporting the cylindrical filter, and a support member made of metal being arranged in the housing,
the cylindrical member including a cylindrical main body portion and a plurality of independent protrusions or an annular protrusion protruding inwardly from an inner wall surface of the cylindrical main body portion,
the plurality of independent protrusions including an annular protruding wall surface and a tip surface surrounded by the annular protruding wall surface,
the annular protrusion including an annular tip surface, a first annular protruding wall surface and a second annular protruding wall surface, the first annular protruding wall surface and the second annular protruding wall surface each extending, from both sides of the annular tip surface in the width direction, to an inner wall surface of the housing,
the cylindrical main body portion being abutting against the second peripheral wall portion of the housing, and the plurality of independent protrusions or the annular protrusion being spaced from the first peripheral wall portion in a radial direction,
the support member including an annular planar portion provided with a plurality of through-holes in a thickness direction thereof, and an annular bent portion bent in one direction from an outer peripheral portion of the annular planar portion,
the support member being configured such that an inner peripheral portion of the annular planar portion is abutting against a peripheral wall portion of the cup member, and a tip portion of the annular bent portion is abutting against the annular protruding wall surface of the plurality of independent protrusions or the first annular protruding wall surface of the annular protrusion, and
the cylindrical filter being arranged in a state in which the outer peripheral wall surface thereof is abutting against the cylindrical main body portion of the cylindrical member, the inner peripheral wall surface thereof is abutting against the peripheral wall portion of the cup member, the first annular end surface thereof is abutting against the top plate, and the second annular end surface thereof is abutting against the annular planar portion of the support member.
